(19) United States
(12) Patent Application Publication
(10) Pub. No.: US 2004/0246958 A1
(43) Pub. Date: Dec. 9, 2004

(54) Apparatus and mehtod for selecting one among multiple internet service providers and routing using the selected one

(75) Inventors: Hak-goo Lee, Suwon-si (KR); Pyung-soo Kim, Seoul (KR); Jae-hwang Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/860,024

(22) Filed: Jun. 4, 2004

(30) Foreign Application Priority Data
Jun. 5, 2003 (KR) 2003-36327

(51) Int. Cl. H04L 12/56

(52) U.S. Cl. 370/389; 370/395.21

(57) ABSTRACT

An apparatus and method for selecting one among multiple Internet service providers (ISPs) and routing using the selected ISP are provided. The method includes exchanging an address of a second ISP replacing a first ISP that has stopped an Internet access service and an address of an external node that has been connected to the first ISP, and transmitting a data packet having the address of the external node as a next destination address.

### BACKGROUND OF THE INVENTION

This application claims the priority of Korean Patent Application No. 2003-36327, filed on Jun. 5, 2003, in the Korean Intellectual Property Office, the disclosure of which is incorporated herein in its entirety by reference.

1. Field of the Invention

The present invention relates to an apparatus and method for selecting one among multiple internet service providers (ISPs) and routing using the selected ISP, a transmitting and receiving apparatus and method using multiple ISPs, and a system and method for selecting one among multiple ISPs and using the selected ISP.

2. Description of the Related Art

FIGS. 1A and 1B are diagrams illustrating a conventional network using a multi-pass under an Internet Protocol version 4 (IPv4) environment. Referring to FIGS. 1A and 1B, the conventional network using the multi-pass under the IPv4 environment includes a multi-pass 11, A, B, and C hosts 12, 13, and 14, a first ISP 15, a second ISP 16, Internet 17, and a server 18.

Referring to FIG. 1A, the multi-pass 11 is an edge router of the first ISP 15, accesses an access router having an Internet Protocol (IP) address of 10.0.0.1, and is allocated an IP address of 10.0.0.2 through a data link layer according to a Point-to-Point Protocol (PPP). The multi-pass 11 is connected to the first ISP 15 through a cable. Similarly, the multi-pass 11 is an edge router of the second ISP 16, accesses an access router having an IP address of 20.0.0.1, and is allocated an IP address of 20.0.0.2 through the data link layer according to the PPP. The multi-pass 11 is connected to the second ISP 16 through an x Digital Subscriber Line (xDSL).

The multi-pass 11 allocates a private IP address of 192.0.0.2 to the A host 12, a private IP address of 192.0.0.3 to the B host 13, a private IP address of 192.0.0.4 to the C host 14, and a private IP address of 192.0.0.1 to itself.

Referring to FIG. 1B, the multi-pass 11 fluidly allocates an IP address to each of the A host 12, the B host 13, and the C host 14 so that the A host 12, the B host 13, and the C host 14 can be connected to the first and second ISPs 15 and 16 that provide an Internet access service. In other words, the multi-pass 11 performs conversion between a private IP address and a public IP address using a Network Address Translation (NAT) protocol, thereby providing a solution for a problem of lack of IP addresses in an IPv4 environment. In addition, the multi-pass 11 does not use a private line but uses a plurality of public lines such as xDSLs or cables requiring low communication costs, thereby providing reliability and decreasing communication costs.

However, when the conventional NAT protocol is used and when a problem occurs in a certain public line, although communication can be continued by accessing the Internet using another public line, a connection-oriented Transmission Control Protocol (TCP) layer is disconnected due to a change of an IP address.

If an IPv6 environment is widely spread, the lack of IP addresses will be overcome. However, conventionally, an apparatus for guaranteeing reliability and decreasing communication costs by using a plurality of public lines such as xDSLs or cables requiring low communication costs without using a private line under the IPv6 environment does not exist.

FIG. 2 is a diagram illustrating a conventional intranet using a multi-pass under the IPv4 environment. The multi-pass is usually used in branch offices of a company or a bank that uses an intranet or in Internet cafes using private IP addresses.

Referring to FIG. 2, a branch intranet including hosts 22 through 24 accesses the Internet via a multi-pass 21 and finally reaches an external web server 25 or a main intranet including hosts 27 through 29 via the Internet. Here, the multi-pass 21 serves as a security gateway and communicates with a security gateway 26 in the main intranet using a tunneling method so that reliability is secured.

Conventionally, each host in a branch intranet accesses the Internet and communicates the external server using the NAT protocol. According to the NAT protocol, a private IP address is used within a multi-pass, and when a packet is sent outside the multi-pass, each node within a private network is identified using table mapping of port numbers in the TCP layer to make end-to-end communication possible. However, using the NAT protocol decreases a throughput of each host and causes a load.

### SUMMARY OF THE INVENTION

The present invention provides an apparatus and method for allowing use of a plurality of public lines instead of a private line in an Internet Protocol version 6 (IPv6) environment and allowing communication to be performed using an existing Internet Protocol (IP) address without changing the existing IP address when instead of a certain public line having a problem, another public line is used to access the Internet.

According to an aspect of the present invention, there is provided a method of selecting one among multiple Internet Service Providers (ISPs) and routing using the selected ISP. The method comprises exchanging an address of a second ISP replacing a first ISP that has stopped an Internet access service and an address of an external node that has been connected to the first ISP, and transmitting a data packet having the address of the external node as a next destination address.

According to another aspect of the present invention, there is provided a multiple Internet Service Provider (ISP) selection/routing apparatus comprising an IP address exchanger which exchanges an address of a second ISP replacing a first ISP that has stopped an Internet access service and an address of an external node that has been connected to the first ISP, and a data packet transmitter which transmits a data packet having the address of the external node as a next destination address.

According to still another aspect of the present invention, there is provided a method of performing transmission and reception using multiple Internet Service Providers (ISPs). The method comprises receiving a router advertisement message comprising an address of a second ISP replacing a first ISP that has stopped an Internet access service, and transmitting a data packet having an address of the external node, which has been connected to the first ISP, as a final destination address, and the address of the second ISP comprised in the router advertisement message as a next destination address.

According to still another aspect of the present invention, there is provided a computer readable recording medium for storing a program for executing in a computer a method of selecting one among multiple Internet Service Providers (ISPs) and routing using the selected ISP. The method comprises exchanging an address of a second ISP replacing a first ISP that has stopped an Internet access service and an address of an external node that has been connected to the first ISP, and transmitting a data packet having the address of the external node as a next destination address.

According to still another aspect of the present invention, there is provided a computer readable recording medium for storing a program for executing in a computer a method of performing transmission and reception using multiple Internet Service Providers (ISPs). The method comprises receiving a router advertisement message comprising an address of a second ISP replacing a first ISP that has stopped an Internet access service, and transmitting a data packet having an address of the external node, which has been connected to the first ISP, as a final destination address, and the address of the second ISP comprised in the router advertisement message as a next destination address.

### BRIEF DESCRIPTION OF THE DRAWINGS

The above and other features and advantages of the present invention will become more apparent by describing in detail preferred embodiments thereof with reference to the attached drawings in which:

FIGS. 1A and 1B are diagrams illustrating a conventional network using a multi-pass under an Internet Protocol version 4 (IPv4) environment;

FIG. 2 is a diagram illustrating a conventional intranet using a multi-pass under the IPv4 environment;

FIGS. 3A and 3B are diagrams illustrating an IPv6 network environment using the present invention;

FIGS. 4A through 4F are diagrams showing structures of a multiple Internet Service Provider (ISP) using system according to an embodiment of the present invention;

FIG. 5 is a diagram showing a format of a router advertisement message used in the present invention;

FIG. 6 is a diagram showing a format of a prefix information option among the options shown in FIG. 5;

FIG. 7 is a diagram showing formats of an IP header and a routing header which are used in the present invention;

FIG. 8 is a diagram showing a multiple ISP selection/routing apparatus according to the embodiment of the present invention;

FIG. 9 is a diagram showing a first multiple ISP transmit-receive apparatus according to the embodiment of the present invention;

FIG. 10 is a diagram showing a second multiple ISP transmit-receive apparatus according to the embodiment of the present invention;

FIGS. 11A through 11C are flowcharts of a method of selecting one among multiple ISPs and routing using the selected ISP according to an embodiment of the present invention;

FIGS. 12A through 12C are flowcharts of a method of performing transmission and reception using multiple ISPs according to the embodiment of the present invention;

FIG. 13 is a flowchart of another method of performing transmission and reception using multiple ISPs according to the embodiment of the present invention; and

FIGS. 14A through 14C are flowcharts of a method of selecting one among multiple ISPs and using the selected ISP according to the embodiment of the present invention.

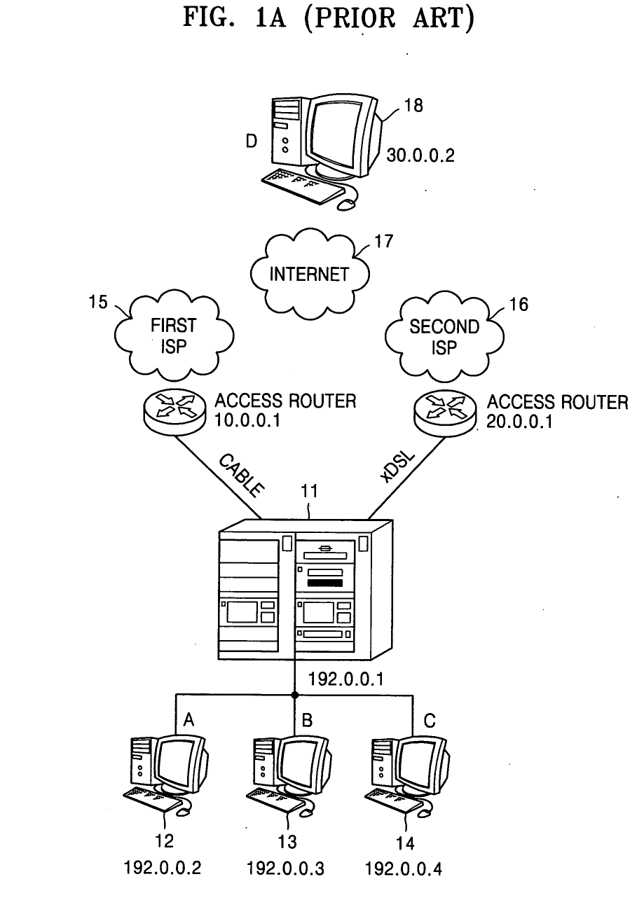

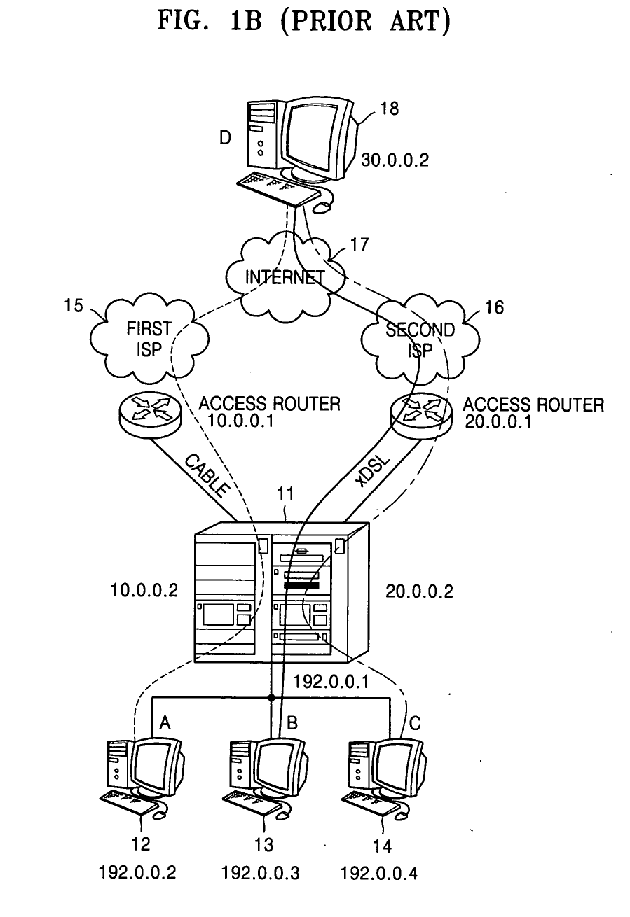

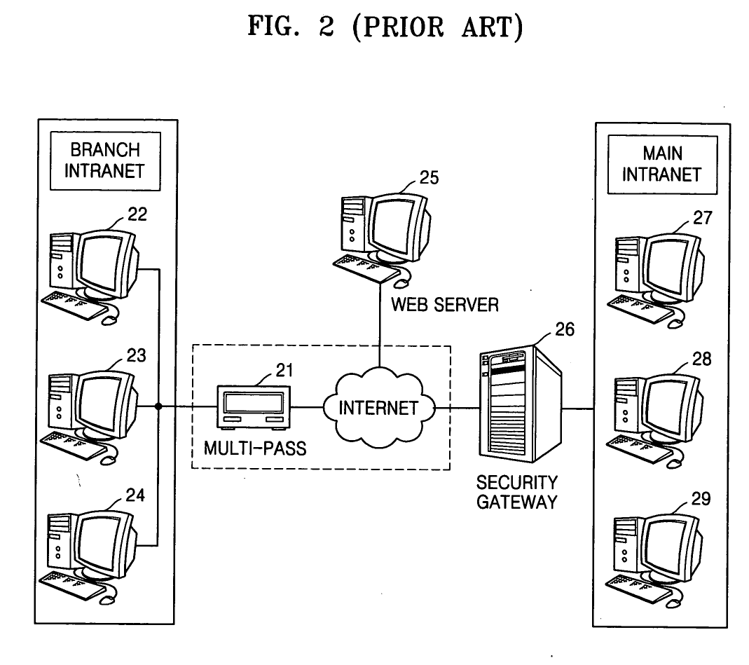

### DETAILED DESCRIPTION OF THE INVENTION

Hereinafter, preferred embodiments of the present invention will be described in detail with reference to the attached drawings.

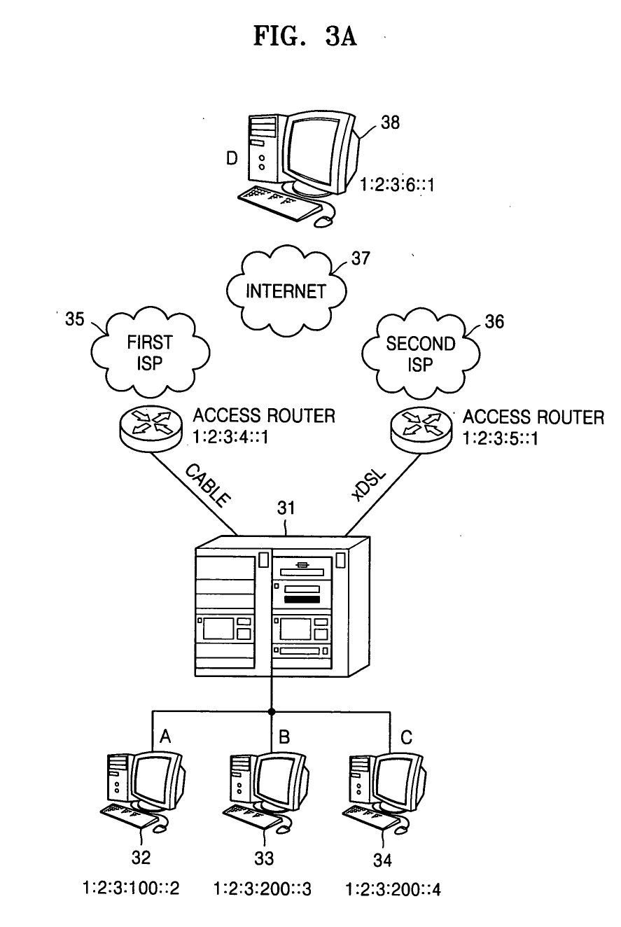

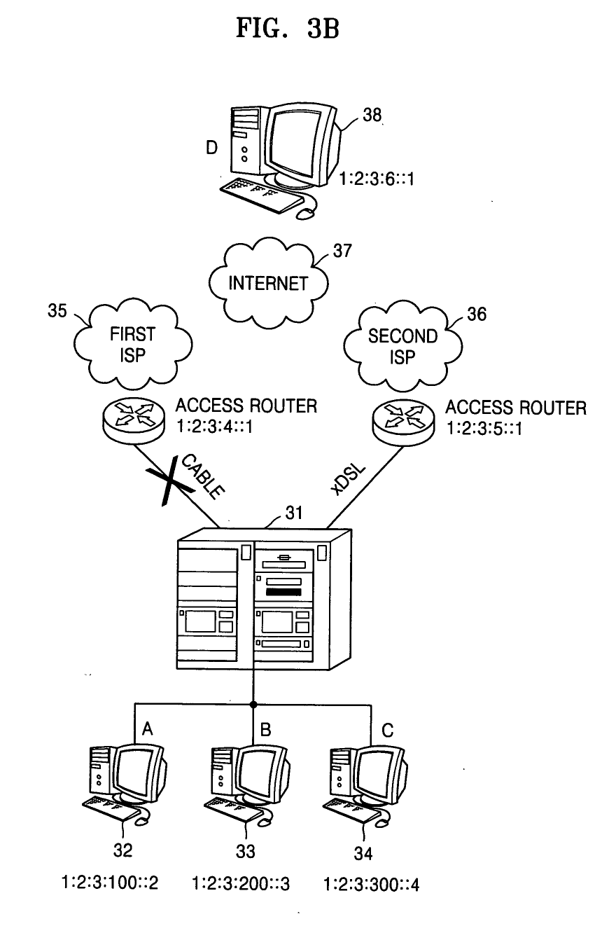

FIGS. 3A and 3B are diagrams illustrating an Internet Protocol version 6 (IPv6) network environment using the present invention. Referring to FIG. 3A, the IPv6 network environment includes a router 31, A through C hosts 32 through 34, a first Internet Service Provider (ISP) 35, a second ISP 36, Internet 37, and a server D 38.

The router 31 is an edge router of the first ISP 35, accesses an access router having an IP address 1:2:3:4::1/64, and is allocated a prefix 1:2:3:100::0/64 through a data link layer according to a Point-to-Point Protocol (PPP). Here, the router 31 is connected to the first ISP 35 through a cable. Similarly, the router 31 is an edge router of the second ISP 36, accesses an access router having an IP address 1:2:3:5::1/64, and is allocated a prefix 1:2:3:200::0/64 through the data link layer according to the PPP. Here, the router 31 is connected to the second ISP 36 through an x Digital Subscriber Line (xDSL).

The router 31 transmits a router advertisement message including a prefix field, in which the prefix 1:2:3:100::0/64 allocated by the first ISP 35 is recorded, to the A host 32. Then, the A host 32 adds its interface ID to the prefix 1:2:3:100::0/64 to generate an IP address 1:2:3:100::2. Thereafter, the A host 32 sets the generated IP address 1:2:3:100::2 as its own IP address and communicates with the server D38 via the Internet 37 accessed using an Internet access service provided by the first ISP 35. Similarly, the router 31 transmits a router advertisement message including a prefix field, in which the prefix 1:2:3:200::0/64 allocated by the second ISP 36 is recorded, to the B host 33. Then, the B host 33 adds its interface ID to the prefix 1:2:3:200::0/64 to generate an IP address 1:2:3:200::3. Thereafter, the B host 33 sets the generated IP address 1:2:3:200::3 as its own IP address and communicates with the server D38 via the Internet 37 accessed using an Internet access service provided by the first ISP 36. Similarly, the router 31 transmits a router advertisement message including a prefix field, in which the prefix 1:2:3:200::0/64 allocated by the second ISP 36 is recorded, to the C host 34. Then, the C host 34 adds its interface ID to the prefix 1:2:3:200::0/64 to generate an IP address 1:2:3:200::4. Thereafter, the C host 34 sets the generated IP address 1:2:3:200::4 as its own IP address and communicates with the server D38 via the Internet 37 accessed using an Internet access service provided by the second ISP 36.

Referring to FIG. 3B, when the connection between the router 31 and the first ISP 35 is broken due to various causes, the first ISP 35 cannot provide the Internet access service to the router 31 and other connected nodes. Accordingly, the A host 32 using the prefix provided by the first ISP 35 cannot access the Internet 37 any more and consequently cannot communicate with the server D 38.

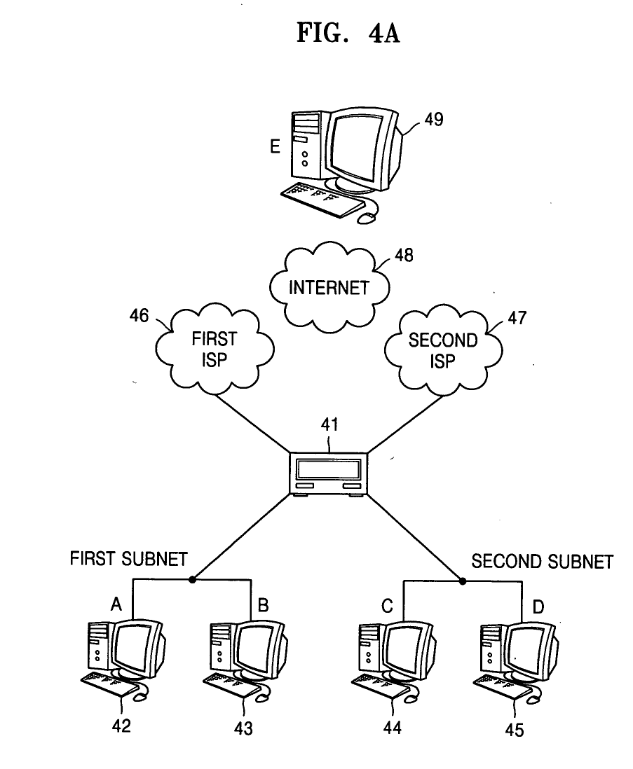

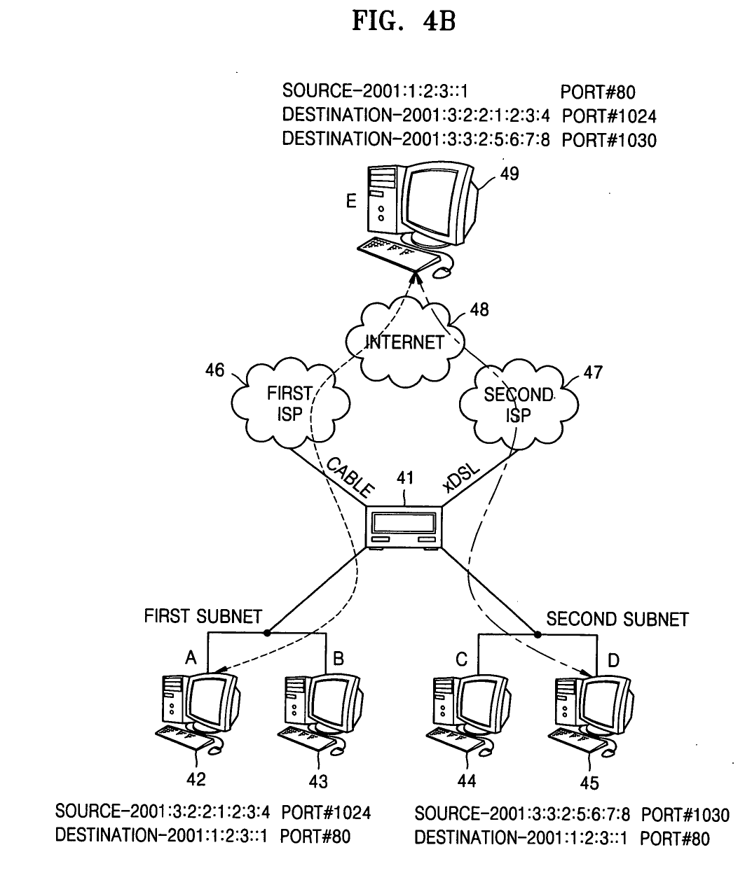

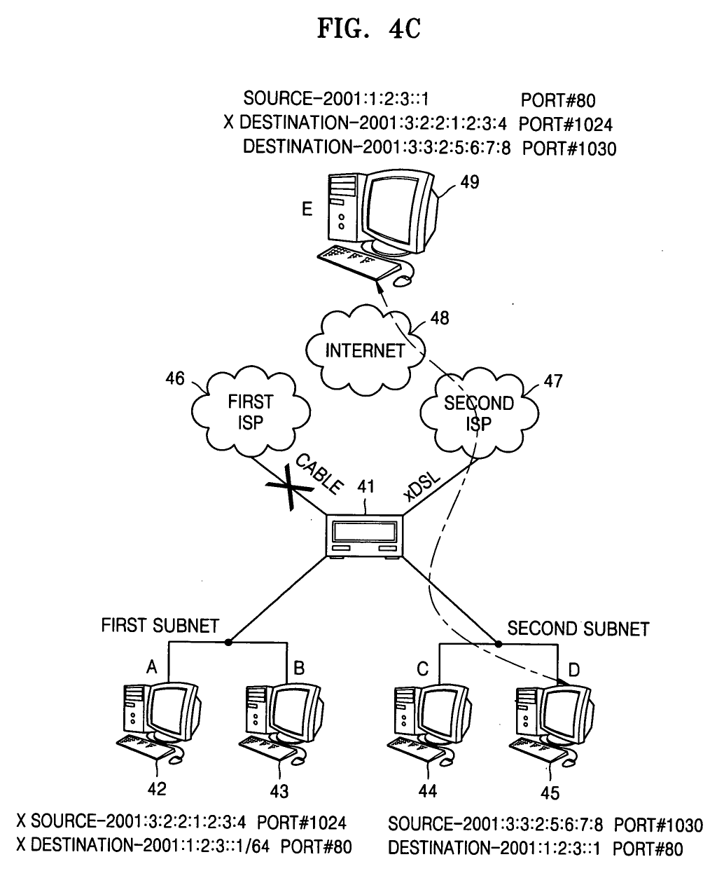

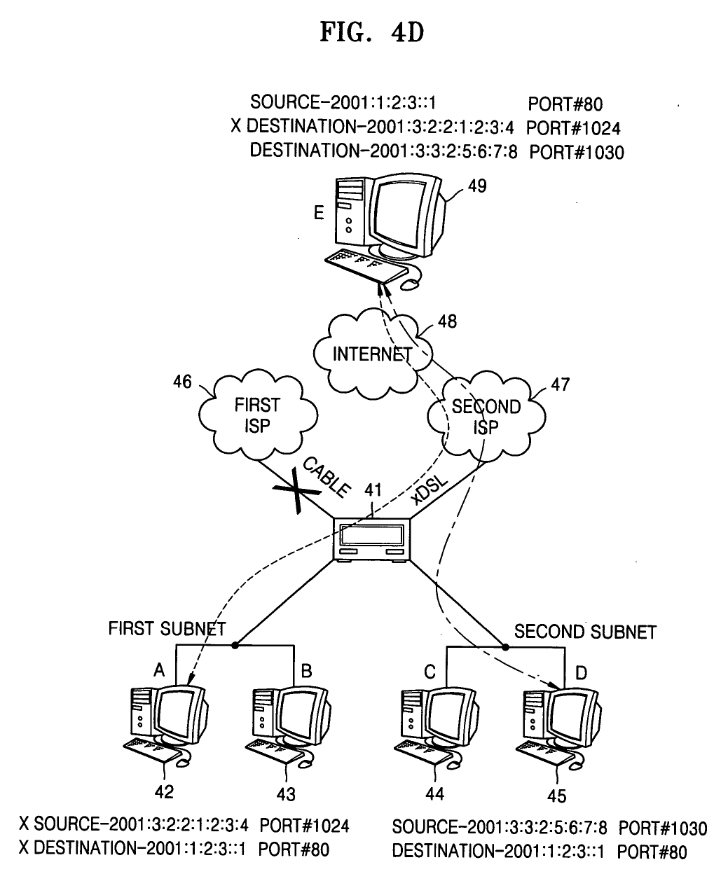

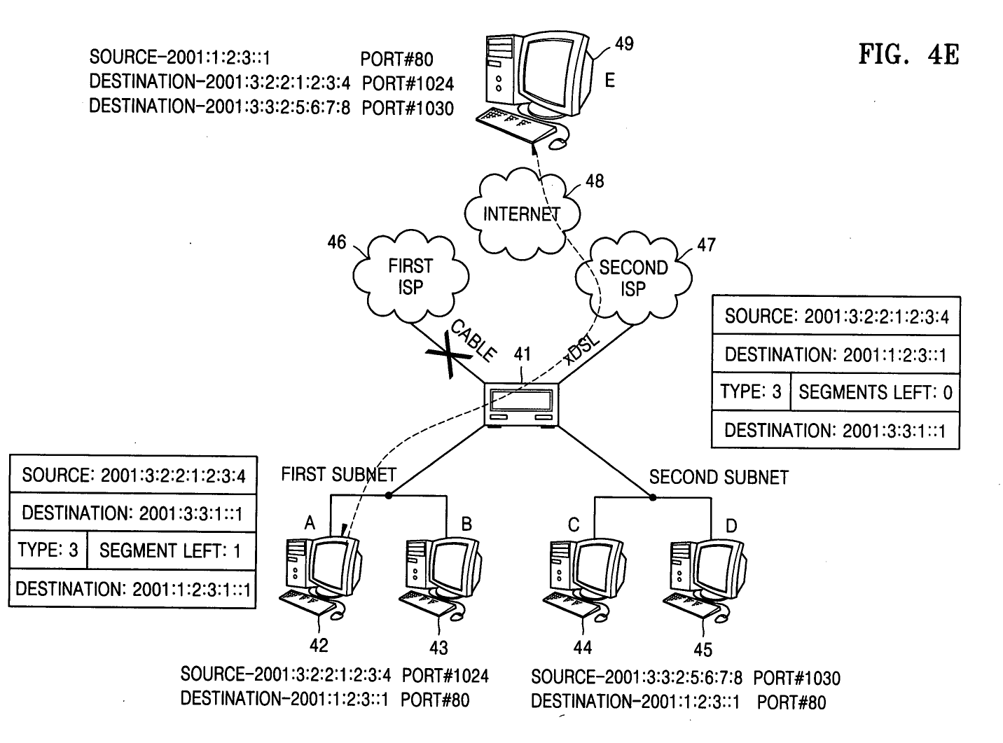

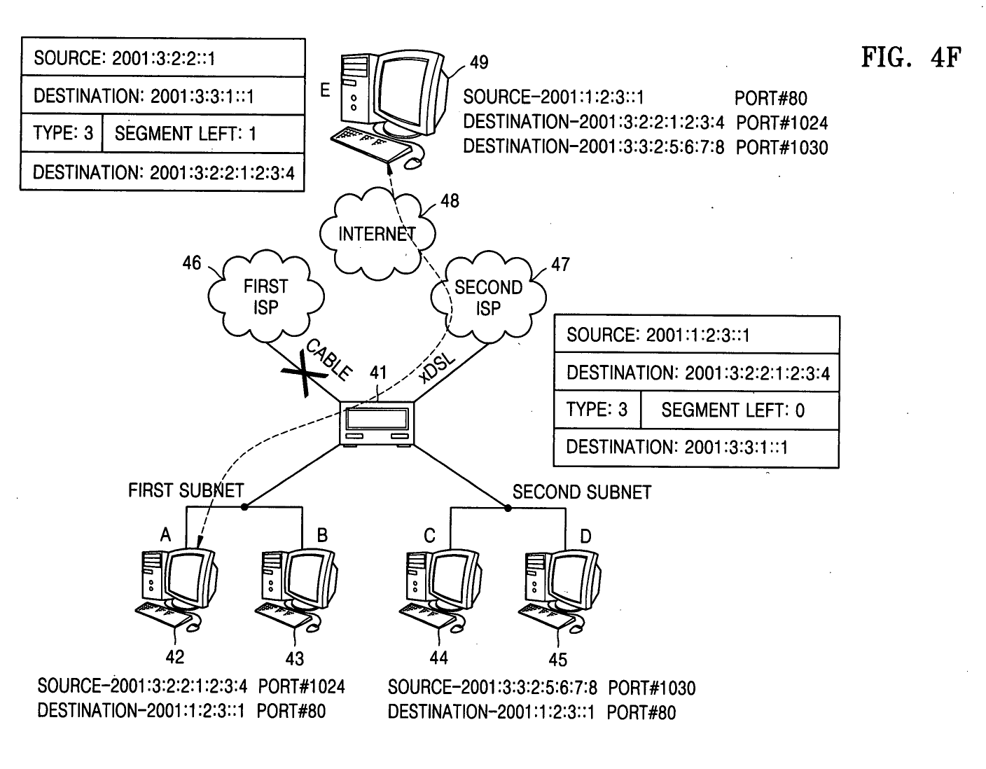

FIGS. 4A through 4F are diagrams showing structures of a multiple ISP using system according to an embodiment of the present invention.

Referring to FIG. 4A, the multiple ISP using system includes a multiple ISP selection/routing apparatus 41, a first multiple ISP transmit-receive apparatus 42, and a second multiple ISP transmit-receive apparatus 49.

The multiple ISP selection/routing apparatus 41 is installed in a router. When the router 41 is initialized, the multiple ISP selection/routing apparatus 41 receives Internet access information from the first ISP 46 and the second ISP 47 which are connected to the multiple ISP selection/routing apparatus 41. In other words, the multiple ISP selection/routing apparatus 41 receives a prefix and an IP address which are provided by the first ISP 46 and a prefix and an IP address which are provided by the second ISP 47. Thereafter, the multiple ISP selection/routing apparatus 41 sets the IP address received from the first ISP 46 as an IP address of a first ISP connecting node that is connected to the first ISP 46 in the router 41 and sets the IP address received from the second ISP 47 as an IP address of a second ISP connecting node that is connected to the second ISP 47 in the router 41. In addition, the multiple ISP selection/routing apparatus 41 allocates one of the prefixes provided by the first and second ISPs 46 and 47, respectively, to an appropriate subnet. The subnet is a small sized network and includes a “link” defined in the IPv6 standards.

For example, when the multiple ISP selection/routing apparatus 41 receives a prefix 2001:3:2:2::0/64 and an IP address 2001:3:2:1::1 from the first ISP 46 and a prefix 2001:3:3:2::0/64 and an IP address 2001:3:3:1::1 from the second ISP 47, it sets the IP address 2001:3:2:1::1 as the IP address of the first ISP connecting node and sets the IP address 2001:3:3:1::1 as the IP address of the second ISP connecting node. In addition, the multiple ISP selection/routing apparatus 41 allocates the prefix 2001:3:2:2::0/64 to a first subnet and the prefix 2001:3:3:2::0/64 to a second subnet.

The multiple ISP selection/routing apparatus 41 transmits a router advertisement message to report a prefix allocated to each subnet. The router advertisement message includes a source address field, in which a received IP address is recorded; a destination address field, in which an IP address indicating all nodes existing on each subnet is recorded; and a prefix field, in which a received prefix is recorded. In the above example, a router advertisement message including the source address field having 2001:3:2:1::1 and the prefix field having 2001:3:2:2::0/64 are transmitted to all nodes 42 and 43 existing on the first subnet while a router advertisement message including the source address field having 2001:3:3:1::1 and the prefix field having 2001:3:3:2::0/64 are transmitted to all nodes 44 and 45 existing on the second subnet. According to the IPv6 standards, FF02::2 is recorded in the destination address field in each of the router advertisement messages so that each router advertisement message is multi-cast to all nodes on a corresponding subnet.

The first multiple ISP transmit-receive apparatus 42 is installed in an A host and receives a router advertisement message from the multiple ISP selection/routing apparatus 41. The first multiple ISP transmit-receive apparatus 42 generates an IP address based on a prefix recorded in a prefix field included in the router advertisement message. For example, when the first multiple ISP transmit-receive apparatus 42 receives a router advertisement message including a prefix field having 2001:3:2:2::0/64, it adds the interface ID of the A host 42 to the prefix 2001:3:2:2::0/64 according to stateless auto-configuration defined in the IPv6 standards to generate an IP address 2001:3:2:2:1:2:3:4. Other B through D hosts 43 through 45 generate their IP address in the same manner as described above. For example, when the C host 44 receives a router advertisement message including a prefix field having 2001:3:3:2::0/64, it adds the interface ID of the C host 44 to the prefix 2001:3:3:2::0/64 according to stateless auto-configuration defined in the IPv6 standards to generate an IP address 2001:3:3:2:2:5:6:7.

Referring to FIG. 4B, the first multiple ISP transmit-receive apparatus 42 transmits a first data packet including an IP header and a payload in which first data is recorded. The IP header includes a source address field, in which the generated IP address is recorded, and a destination address field, in which an IP address of an external node is recorded. A Transmission Control Protocol/Internet Protocol (TCP/IP) is a fundamental communication protocol of the Internet. To access the Internet, a user must install a TCP/IP program in his/her computer. The TCP/IP program includes two layers. An upper layer, i.e., a TCP layer, divides a message or a file into smaller packets, transmits them via the Internet, and restores the packets to the original message or file. A lower layer, i.e., an IP layer, processes an address in each packet so that the packet can reach an exact destination. A path between a source node and a destination node is set according to a specified source IP address and a specified destination IP address. To transmit a message or a file over the set path, a TCP port number (#) needs to be specified for the message or the file. In addition, TCP layer connection must be maintained until all packets of the message or the file are transmitted completely. Accordingly, when transmission of a message or a file is interrupted due to various causes such as stop of an ISP's Internet access service, the message or the file needs to be retransmitted from the beginning after a new TCP port # is allocated.

As shown in FIG. 4B, the A host 42 has a source IP address 2001:3:2:2:1:2:3:4, a source TCP port #1024, a destination IP address 2001:1:2:3::1, and a destination TCP port #80. When the first multiple ISP transmit-receive apparatus 42 transmits a first data packet including a payload, in which first data is recorded, and an IP header having a source address field and a destination address field, in which the above IP addresses are respectively recorded, the multiple ISP selection/routing apparatus 41 receives and transmits the first data packet to an E external node 49 having the IP address recorded in the destination address field via the first ISP 46 and the Internet 48. Here, the message or the file is transmitted through the port 1024 of the A host 42 and the port 80 of the E external node 49. The E external node 49 is a server communicating with the A through D hosts 42 through 45 and may be a web server.

Similarly, the C host 44 has a source IP address 2001:3:2:2:5:6:7:8, a source TCP port #1030, a destination IP address 2001:1:2:3::1, and a destination TCP port #80. When the C host 44 transmits a data packet including a payload, in which data is recorded, and an IP header having a source address field and a destination address field, in which the above IP addresses are respectively recorded, the multiple ISP selection/routing apparatus 41 receives and transmits the data packet to the E external node 49 having the IP address recorded in the destination address field via the second ISP 47 and the Internet 48. Here, the message or the file is transmitted through the port 1030 of the C host 44 and the port 80 of the E external node 49.

When the E external node 49 receives a data packet, it transmits a data packet in response to receipt of the data packet or as a new task. Here, the source IP address is 2001:1:2:3::1, and the source TCP port # is 80. The destination IP address and the destination TCP port # may be 2001:3:2:2:1:2:3:4 and 1024, respectively, for the A host 42 or 2001:3:3:2:5:6:7:8 and 1030, respectively, for the C host 44.

Referring to FIG. 4C, when the Internet access service of the first ISP 46 is stopped due to various causes such as a system malfunction and traffic jam, the nodes on the first subnet accessing the Internet 48 using the Internet access service provided by the first ISP 46 cannot access the Internet 48 any more. In this situation, the nodes on the first subnet cannot communicate with the E external node 49 that can be reached through the Internet 48. The A host 42 having the source IP address 2001:3:2:2:1:2:3:4 cannot communicates with the E external node 49. However, the nodes on the second subnet accessing the Internet 48 using the Internet access service provided by the second ISP 47 can continuously access the Internet 48.

Referring to FIG. 4D, the nodes that cannot use the Internet access service provided by the first ISP 46 on the first subnet accesses the Internet 48 using the Internet access service provided by the second ISP 47. When TCP layer connection exists between a source node and a destination node for a message or a file, the IP addresses of the source and destination nodes must not be changed to maintain the TCP layer connection. When the IP addresses are changed in the middle of transmitting the message or the file, the TCP layer connection is broken, and transmission of the message or the file must be newly performed from the beginning. If TCP layer connection is broken when a message or file having a large amount of data has been almost transmitted, system efficiency is badly affected because the transmission must be newly performed from the beginning.

Referring to FIG. 4E, another ISP is selected to transmit a data packet from the A host 42 to the E external node 49 while TCP layer connection is maintained, according to the present invention.

More specifically, when the first ISP 46 stops the Internet access service, the multiple ISP selection/routing apparatus 41 selects the second ISP 47 providing the Internet access service and newly allocates the prefix provided by the second ISP 47 to the first subnet that has been allocated the prefix by the first ISP 46. The multiple ISP selection/routing apparatus 41 transmits a router advertisement message, which includes a source address field having the IP address provided by the second ISP 47, a destination address field having the IP address indicating all of nodes 42 and 43 existing on the first subnet, and a prefix field having the prefix allocated by the second ISP 47.

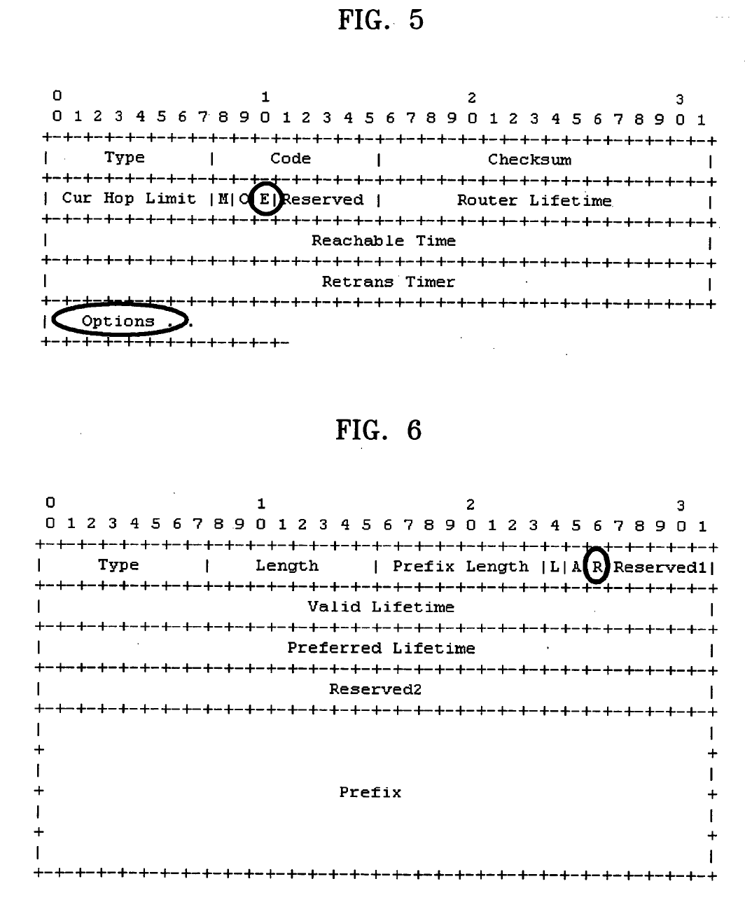

FIG. 5 is a diagram showing a format of a router advertisement message used in the present invention. The router advertisement message usually conforms to the IPv6 standards but further includes a new E flag. Setup of the E flag means that an ISP that has been used stops the Internet access service, and therefore, another ISP needs to be used. Accordingly, when the first ISP 46 stops the Internet access service the E flag included in the router advertisement message transmitted from the multiple ISP selection/routing apparatus 41 must be set. The E flag is just an example and is not indispensable. Other expressions instead of the E flab may be used. A new prefix is recorded in the prefix field included in the router advertisement message. Accordingly, based on such router advertisement message including the prefix field having the new prefix, it can be inferred that an old ISP has stopped the Internet access service and using of a new ISP is required.

FIG. 6 is a diagram showing a format of a prefix information option among the options included in the router advertisement message shown in FIG. 5. Referring to FIG. 6, setup of an R flag in the prefix information option means that the prefix recorded in the prefix field is transmitted from a router. Accordingly, when the first ISP 46 stops the Internet access service, the R flag of the prefix information option included in the router advertisement message transmitted from the multiple ISP selection/routing apparatus 41 must be set.

Referring back to FIG. 4E, the first multiple ISP transmit-receive apparatus 42 receives the router advertisement message from the multiple ISP selection/routing apparatus 41. If TCP layer connection between a source node and a destination node exists with respect to second data, that is, if the second data divided into a plurality of packets are being transmitted, the first multiple ISP transmit-receive apparatus 42 transmits a second data packet including an IP header, a routing header, and a payload. The IP header includes a source address field having the IP address based on the prefix, which is provided by the first ISP 46 having stopped the Internet access service and is recorded in the prefix field included in an IP header of the received router advertisement message, and a destination address field having the IP address provided by the second ISP 47 providing the Internet access service. The routing header includes an address field having the IP address of the E external node 49 Which can be reached via the Internet 48. The payload includes the second data.

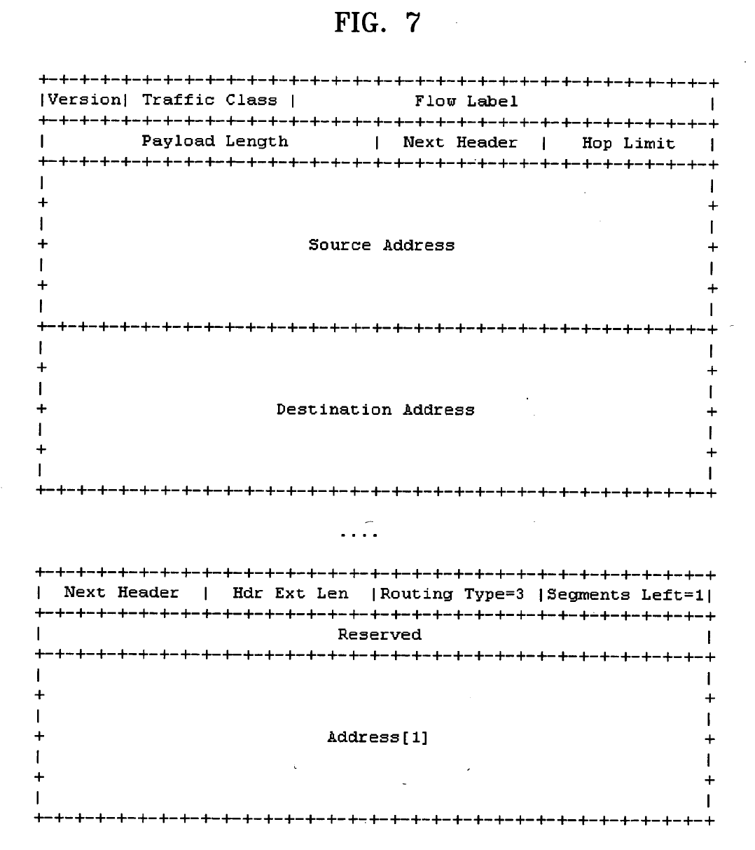

FIG. 7 is a diagram showing formats of an IP header and a routing header which are used in the present invention. Referring to FIG. 7, the formats of the IP header and the routing header conform to the IPv6 standards. The routing header is an extension header. If a value of 43 is recorded in a next header of the IP header, an extension header succeeding the IP header is the routing header. The routing header may include a plurality of address fields. IP addresses recorded in the plurality of address fields are the IP addresses of nodes on a path from a source node to a destination node.

In the IPv6 standards, a routing type is usually set to 0. In addition, it is defined that when a node having received a data packet including a routing header transmits the data packet using another routing header, the data packet should be authenticated. In the present invention, the routing type is set to 3, and authentication of a data packet is omitted. However, the present invention does not exclude transmission of an authenticated data packet, but a data packet in the present invention is irrespective of authentication.

In the present invention, to change an ISP without changing a source IP address and a destination IP address, the destination IP address is first set to an IP address of a connecting node of a changed ISP and is then reset to the original destination IP address using a routing header. Accordingly, a value of segments left indicating the number of nodes to be passed through is set to 1, and only a single address field is required.

Referring back to FIG. 4E, the original source address 2001:3:2:2:1:2:3:4 and the address 2001:3:3:1::1 of the second ISP connecting node of the router 41 are respectively recorded in the source address field and the destination address field, which are included in the IP header of the second data packet forwarded by the first multiple ISP transmit-receive apparatus 42. In addition, the original destination address 2001:1:2:3::1 is recorded in the address field included in the routing header of the second data packet. Accordingly, the second data packet reaches the router 41 that has the address 2001:3:3:1::1 recorded in the destination address field included in the IP header of the second data packet as its own IP address.

The multiple ISP selection/routing apparatus 41 receives the second data packet and exchanges the IP addresses between the destination address field included in the IP header of the second data packet and the address field included in the routing header of the second data packet. As a result, as shown in FIG. 4E, the original source address 2001:3:2:2:1:2:3:4 and the original destination address 2001:1:2:3::1 are respectively recorded in the source address field and the destination address field, which are included in the IP header. The address 2001:3:3:1::1 of the second ISP connecting node of the router 41 is recorded in the address field included in the routing header. Accordingly, when the first ISP 46 suddenly stops the Internet access service, the existing IP address based on the prefix provided by the first ISP 46 is continuously used without generating a new IP address using a new prefix allocated by another ISP so that a message or a file which has been transmitted can be continuously transmitted.

The multiple ISP selection/routing apparatus 41 forwards a third data packet including the exchanged IP header, the exchanged routing header, and the payload of the second data packet. The third data packet has different IP and routing headers than the second data packet, but it has the same data as the second data packet.

The second multiple ISP transmit-receive apparatus 49 receives the third data packet from the multiple ISP selection/routing apparatus 41.

When TCP layer connection between the source node and the destination node for the second data does not exist, that is, when transmission of a new message or file is required, a routing header is not necessary because maintaining TCP layer connection is not required. It is more efficient to generate a new IP address using a new prefix allocated by an ISP providing an Internet access service and transmit a data packet using the generated IP address.

More specifically, the first multiple ISP transmit-receive apparatus 42 generates an IP address based on the prefix, which is provided by the second ISP 47 and is recorded in the prefix field included in the received router advertisement message. Thereafter, the first multiple ISP transmit-receive apparatus 42 forwards a sixth data packet having an IP header and a payload. Here, the IP header includes a source address field having the generated IP address and a destination address field having the IP address of the E external node 49, and the payload includes the second data.

The multiple ISP selection/routing apparatus 41 receives the sixth data packet from the first multiple ISP transmit-receive apparatus 42 and forwards the received sixth data packet.

Referring to FIG. 4F, a data packet is transmitted from the E external node 49 to the A host 42 using another ISP while TCP layer connection is maintained, according to the present invention.

More specifically, when the third data packet is received and when TCP layer connection between the source and destination nodes for the third data exists, the second multiple ISP transmit-receive apparatus 49 forwards a fourth data packet including an IP header, a routing header, and a payload. Here, the IP header includes a source address field having the IP address of the E external node 49 and a destination address field having the IP address provided by the second ISP 47. The routing header includes an address field having the IP address based on the prefix provided by the first ISP 46. The payload has the third data. As shown in FIG. 4F, the original source address 2001:1:2:3::1 and the address 2001:3:3:1::1 of the second ISP connecting node of the router 41 are respectively recorded in the source address field and the destination address field, which are included in the IP header of the fourth data packet forwarded by the second multiple ISP transmit-receive apparatus 49. In addition, the original destination address 2001:3:2:2:1:2:3:4 is recorded in the address field included in the routing header of the fourth data packet. Accordingly, the fourth data packet reaches the router 41 whose IP address is 2001:3:3:1::1 recorded in the destination address field included in the IP header.

The multiple ISP selection/routing apparatus 41 receives the fourth data packet from the second multiple ISP transmit-receive apparatus 49 via the Internet 48 and the second ISP 47 and exchanges the IP addresses between the destination address field included in the IP header of the fourth data packet and the address field included in the routing header of the fourth data packet. As a result, as shown in FIG. 4F, the original source address 2001:1:2:3::1 and the original destination address 2001:3:2:2:1:2:3:4 are respectively recorded in the source address field and the destination address field, which are included in the IP header. The address 2001:3:3:1::1 of the second ISP connecting node of the router 41 is recorded in the address field included in the routing header. Accordingly, when the second multiple ISP transmit-receive apparatus 49 transmits a data packet using a routing header, the existing IP address based on the prefix provided by the first ISP 46 is continuously used without generating a new IP address using a new prefix allocated by another ISP so that a message or a file that has been transmitted can be continuously transmitted.

The multiple ISP selection/routing apparatus 41 forwards a fifth data packet including the exchanged IP header, the exchanged routing header, and the payload of the fourth data packet. The fifth data packet has different IP and routing headers than the fourth data packet, but it has the same data as the fourth data packet.

The first multiple ISP transmit-receive apparatus 42 receives the fifth data packet from the multiple ISP selection/routing apparatus 41.

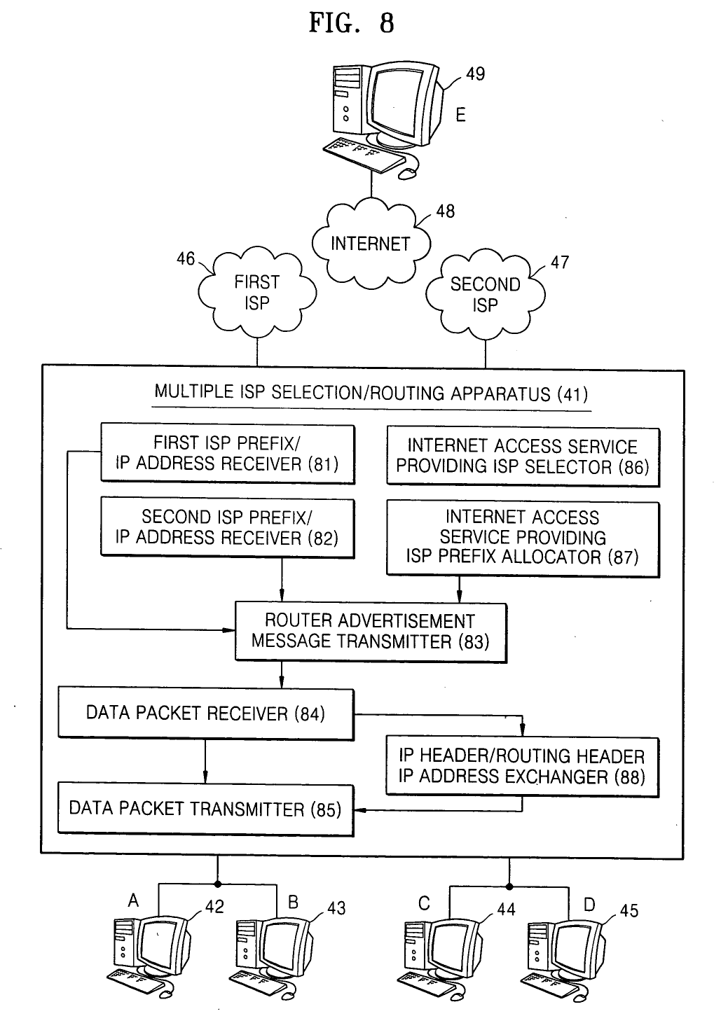

FIG. 8 is a diagram showing the multiple ISP selection/routing apparatus 41 according to the embodiment of the present invention. The multiple ISP selection/routing apparatus 41 includes a first ISP prefix/IP address receiver 81, a second ISP prefix/IP address receiver 82, a router advertisement message transmitter 83, a data packet receiver 84, a data packet transmitter 85, an Internet access service providing ISP selector 86, an Internet access service providing ISP prefix allocator 87, and an IP header/routing header IP address exchanger 88.

The following description concerns an operation of routing a data packet from the A host 42 to the E external node 49 in a normal environment in which both of the first and second ISPs 46 and 47 provide an Internet access service.

The first ISP prefix/IP address receiver 81 receives a prefix and an IP address, which are provided by the first ISP 46. The second ISP prefix/IP address receiver 82 receives a prefix and an IP address which are provided by the second ISP 47.

The router advertisement message transmitter 83 transmits a router advertisement message to all nodes on the first subnet, i.e., the A host 42 and the B host 43. Here, the router advertisement message includes a source address field having the IP address received by the first ISP prefix/IP address receiver 81, a destination address field having an IP address indicating all of the nodes on the first subnet, and a prefix field having the prefix received by the first ISP prefix/IP address receiver 81.

The data packet receiver 84 receives a first data packet including an IP header and a payload from the A host 42. Here, the IP header includes a source address field having an IP address based on the prefix, which is received by the first ISP prefix/IP address receiver 81 and is recorded in the prefix field of the router advertisement message transmitted by the router advertisement message transmitter 83, and a destination address field having an IP address of the E external node 49. The payload includes first data.

The data packet transmitter 85 transmits the first data packet received by the data packet receiver 84 to the E external node 49 via the first ISP 46 and the Internet 48. In such normal environment, a data packet is transmitted from the E external node 49 to the A host 42 back through the above-described operations.

The following description concerns an operation of routing a data packet from the A host 42 to the E external node 49 while maintaining TCP layer connection in an environment where the first ISP 46 stops the Internet access service but the second ISP 47 provides the Internet access service.

When the first ISP 46 stops the Internet access service, the Internet access service providing ISP selector 86 selects the second ISP 47 providing the Internet access service.

The Internet access service providing ISP prefix allocator 87 allocates the prefix provided by the second ISP 47 selected by the Internet access service providing ISP selector 86 to the first subnet that has been allocated the prefix provided by the first ISP 46.

The router advertisement message transmitter 83 transmits a router advertisement message to all of the nodes on the first subnet, i.e., the A host 42 and the B host 43. Here, the router advertisement message includes a source address field having the IP address provided by the second ISP 47, a destination address field having an IP address indicating all of the nodes on the first subnet, and a prefix field having the prefix allocated by the Internet access service providing ISP prefix allocator 87.

Upon receiving the router advertisement message including the prefix field having the prefix allocated by the Internet access service providing ISP prefix allocator 87 from the router advertisement message transmitter 83, the data packet receiver 84 receives a second data packet including an IP header, a routing header, and a payload from the A host 42. Here, the IP header includes a source address field having an IP address based on the prefix, which is provided from the first ISP 46 that has stopped the Internet access service, and a destination address field having the IP address provided by the second ISP 47 providing the Internet access service. The routing header includes an address field having the IP address of the E external node 49 that can be reached via the Internet 48. The payload includes second data.

The IP header/routing header IP address exchanger 88 exchanges the IP address between the destination address field included in the IP header of the second data packet and the address field included in the routing header of the second packet.

The data packet transmitter 85 transmits a third data packet to the E external node 49 via the second ISP 47 and the Internet 48. The third data packet includes the exchanged IP header, the exchanged routing header, and the payload of the second data packet.

The following description concerns an operation of routing a data packet different from a data packet received by the E external node 49 from the E external node 49 to the A host 42 while maintaining TCP layer connection in an environment where the first ISP 46 stops the Internet access service but the second ISP 47 provides the Internet access service.

The data packet receiver 84 receives a fourth data packet including an IP header, a routing header, and a payload from the E external node 49 via the Internet 48 and the second ISP 47. Here, the IP header includes a source address field having the IP address of the E external node 49 that has received the third data packet from the data packet transmitter 85 and a destination address field having the IP address provided by the second ISP 47. The routing header includes an address field having an IP address based on the prefix provided by the first ISP 46. The payload has third data.

The IP header/routing header IP address exchanger 88 exchanges the IP address between the destination address field included in the IP header of the fourth data packet and the address field included in the routing header of the fourth packet.

The data packet transmitter 85 transmits a fifth data packet including the exchanged IP header, the exchanged routing header, and the payload of the fourth data packet to the A host 42.

The following description concerns an operation of routing a data packet from the A host 42 to the E external node 49 after newly setting TCP layer connection in an environment where the first ISP 46 stops the Internet access service but the second ISP 47 provides the Internet access service.

The data packet receiver 84 receives a sixth data packet including an IP header and a payload from the A host 42. Here, the IP header includes a source address field having an IP address based on the prefix, which has been allocated by the Internet access service providing ISP prefix allocator 87 and recorded in the prefix field of the router advertisement message transmitted by the router advertisement message transmitter 83, and a destination address field having the IP address of the E external node 49. The payload has the third data.

The data packet transmitter 85 transmits the sixth data packet received by the data packet receiver 84 to the E external node 49 via the second ISP 47 and the Internet 48. Under such environment, a data packet is transmitted from the E external node 49 to the A host 42 back through the above-described operations.

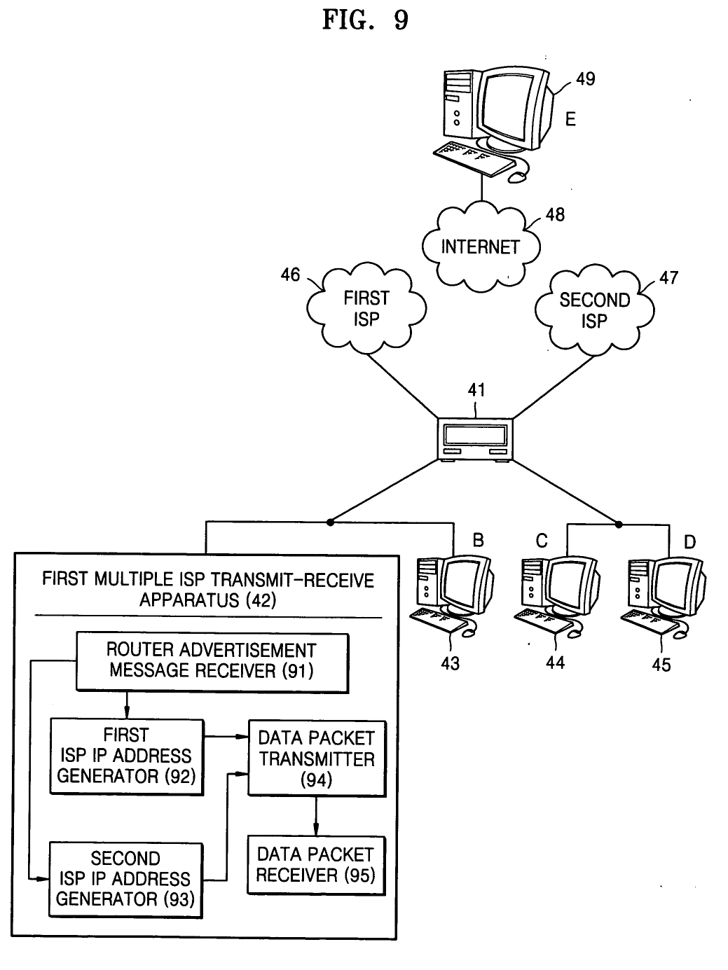

FIG. 9 is a diagram showing the first multiple ISP transmit-receive apparatus 42 according to the embodiment of the present invention. The first multiple ISP transmit-receive apparatus 42 includes a router advertisement message receiver 91, a first ISP IP address generator 92, a second ISP IP address generator 93, a data packet transmitter 94, and a data packet receiver 95.

The following description concerns an operation of transmitting a data packet from the A host 42 to the router 41 in the normal environment where both of the first and second ISPs 46 and 47 provide the Internet access service.

The router advertisement message receiver 91 receives a router advertisement message from the router 41. The router advertisement message includes a source address field having an IP address provided by the first ISP 46, a destination address field having an IP address indicating all nodes on the first subnet, and a prefix field having a prefix provided by the first ISP 46.

The first ISP IP address generator 92 generates an IP address based on the prefix that has been provided by the first ISP 46 and recorded in the prefix field included in the router advertisement message received by the router advertisement message receiver 91.

The data packet transmitter 94 transmits the first data packet including an IP header and a payload to the router 41. The IP header includes a source address field having the IP address generated by the first ISP IP address generator 92 and a destination address field having the IP address of the E external node 49. The payload has the first data. In such normal environment, a data packet is transmitted from the router 41 to the A host 42 back through the above-described operations.

The following description concerns an operation of transmitting a data packet from the A host 42 to the router 41 while maintaining TCP layer connection in an environment where the first ISP 46 stops the Internet access service but the second ISP 47 provides the Internet access service.

The router advertisement message receiver 91 receives a router advertisement message from the router 41. The router advertisement message includes a source address field having an IP address provided by the second ISP 47, a destination address field having an IP address indicating all nodes on the first subnet, and a prefix field having a prefix provided by the second ISP 47.

When the router advertisement message receiver 91 receives the router advertisement message including the prefix field having the prefix provided by the second ISP 47 while TCP layer connection exits between a source node and a destination node for the second data, the data packet transmitter 94 transmits the second data packet including an IP header, a routing header, and a payload to the router 41. Here, the IP header includes a source address field having an IP address based on the prefix, which is provided from the first ISP 46 that has stopped the Internet access service, and a destination address field having the IP address provided by the second ISP 47 providing the Internet access service. The routing header includes an address field having the IP address of the E external node 49 that can be reached via the Internet 48. The payload includes the second data.

The following description concerns an operation of receiving a data packet from the E external node 49 while maintaining TCP layer connection in an environment where the first ISP 46 stops the Internet access service but the second ISP 47 provides the Internet access service.

The data packet receiver 95 receives the fifth data packet including an IP header, a routing header, and a payload. Here, the IP header includes a source address field having the IP address of the E external node 49 receiving the second data packet from the data packet transmitter 94 and a destination address field having an IP address based on the prefix provided by the first ISP 46. The routing header includes an address field having the IP address provided by the second ISP 47. The payload includes the third data.

The following description concerns an operation of transmitting a data packet from the A host 42 to the router 41 after newly setting TCP layer connection in an environment where the first ISP 46 stops the Internet access service but the second ISP 47 provides the Internet access service.

When TCP layer connection does not exist between a source node and a destination node for the third data, the second ISP IP address generator 93 generates an IP address based on the prefix that is provided by the second ISP and is recorded in the prefix field included in the router advertisement message received by the router advertisement message receiver 91.

The data packet transmitter 94 transmits the sixth data packet including an IP header and a payload to the router 41. Here, the IP header includes a source address field having the IP address generated by the second ISP IP address generator 93 and a destination address field having the IP address of the E external node 49. In such environment, a data packet is transmitted from the router 41 to the A host 42 back through the above-described operations.

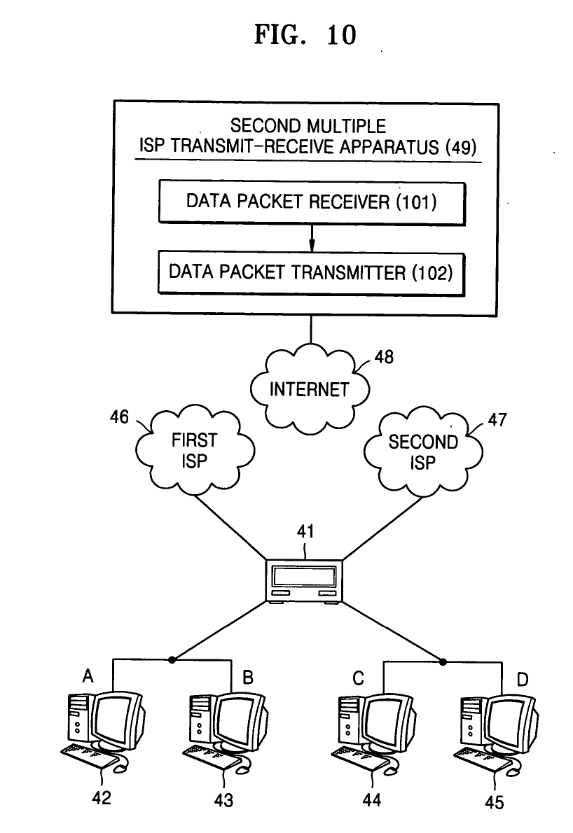

FIG. 10 is a diagram showing the second multiple ISP transmit-receive apparatus 49 according to the embodiment of the present invention. The second multiple ISP transmit-receive apparatus 49 includes a data packet receiver 101 and a data packet transmitter 102.

The following description concerns an operation of maintaining TCP layer connection when the E external node 49 receives a data packet from the Internet 48 and then transmits it to the Internet 48 in an environment where the first ISP 46 stops the Internet access service but the second ISP 47 provides the Internet access service.

The data packet receiver 101 receives third data packet including an IP header, a routing header, and a payload. Here, the IP header includes a source address field having an IP address based on the prefix provided by the ISP 46 that has stopped the Internet access service and a destination address field having the IP address of the E external node 49 that can be reached via the Internet 48. The routing header includes an address field having the IP address provided by the second ISP 47. The payload includes the second data.

When the third data packet is received by the data packet receiver 101 and when TCP layer connection exists between a source node and a destination node for the third data, the data packet transmitter 102 transmits the fourth data packet including an IP header, a routing header, and a payload. Here, the IP header includes a source address field having the IP address of the external node 49 and a destination address field having the IP address provided by the second ISP 47.

The routing header includes an address field having an IP address based on the prefix provided by the first ISP 46. The payload includes the third data.

When data is transmitted and received in the normal environment where both of the first and second ISPs 46 and 47 provide the Internet access service, or when data is transmitted and received after TCP layer connection is newly set in the environment where the first ISP 46 stops the Internet access service but the second ISP 47 provides the Internet access service, the second multiple ISP transmit-receive apparatus 49 conforms to the IPv6 standards because in both cases, the E external node 49 receives a data packet from and transmits a data packet to a node having a new IP address.

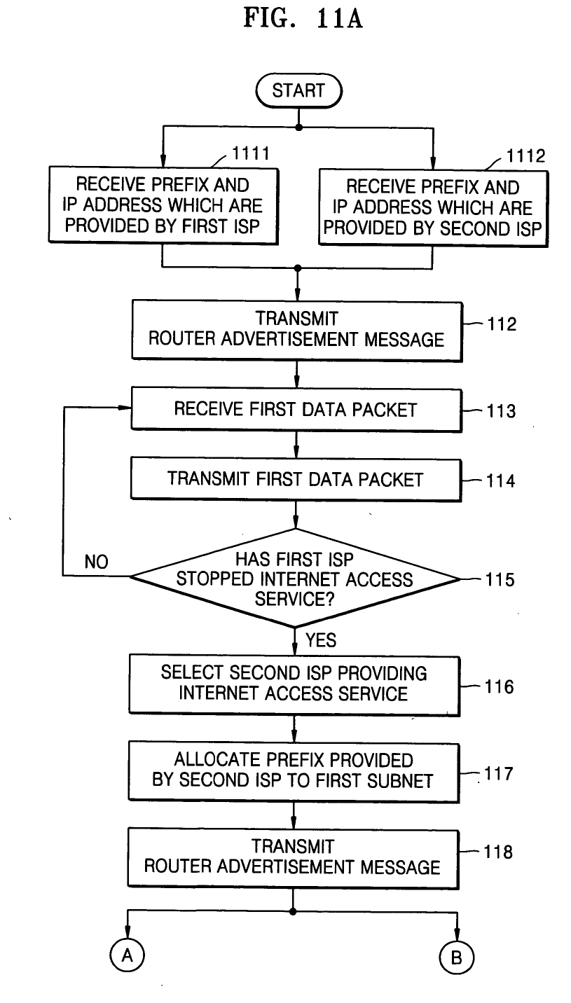

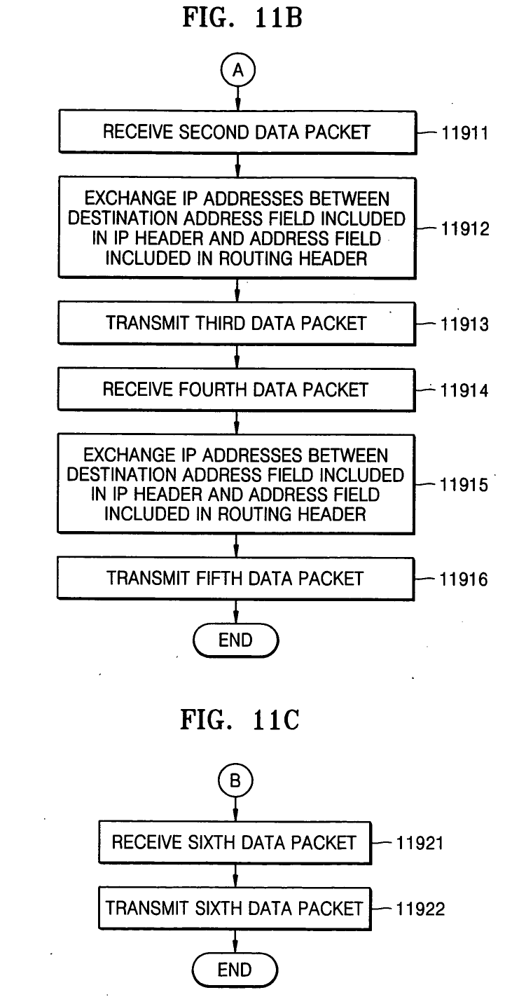

FIGS. 11A through 11C are flowcharts of a method of selecting one among multiple ISPs and routing using the selected ISP according to an embodiment of the present invention.

Referring to FIGS. 11A through 11C, a prefix and an IP address, which are provided by a first ISP, are received in step 1111. A prefix and an IP address, which are provided by a second ISP, are received in step 1112. Next, a router advertisement message is transmitted in step 112. The router advertisement message includes a source address field having the IP address provided by the first ISP, a destination address field having an IP address indicating all nodes on a first subnet, and a prefix field having the prefix provided by the first ISP. Next, a first data packet including an IP header and a payload having first data is received in step 113. Here, the IP header includes a source address field having an IP address based on the prefix provided by the first ISP and a destination address field having an IP address of an external node. Next, the first data packet is transmitted in step 114.

If it is determined that the first ISP has stopped an Internet access service in step 115, the second ISP providing the Internet access service is selected in step 116. Next, the prefix provided by the selected second ISP is allocated to the first subnet that has been allocated the prefix provided by the first ISP in step 117. Next, a router advertisement message is transmitted in step 118. The router advertisement message includes a source address field having the IP address provided by the second ISP, a destination address field having the IP address indicating all of the nodes on the first subnet, and a prefix field having the prefix allocated in step 117.

After step 118, a second data packet is received in step 11911. The second data packet includes an IP header, a routing header, and a payload having second data. The IP header includes a source address field having the IP address based on the prefix provided by the first ISP and a destination address field having the IP address provided by the second ISP. The routing header includes an address field having the IP address of the external node that can be reached via Internet. Next, the IP addresses are exchanged between the destination address field included in the IP header of the second data packet and the address field included in the routing header of the second data packet in step 11912. Next, a third data packet including the exchanged IP header, the exchanged routing header, and the payload of the second data packet is transmitted in step 11913. Next, a fourth data packet is received in step 11914. The fourth data packet includes an IP header, a routing header, and a payload having third data. The IP header includes a source address field having the IP address of the external node that has received the third data packet and a destination address field having the IP address provided by the second ISP. The routing header includes an address field having the IP address based on the prefix provided by the first ISP. Next, the IP addresses are exchanged between the destination address field included in the IP header of the fourth data packet and the address field included in the routing header of the fourth data packet i n step 11915. Next, a fifth data packet including the exchanged IP header, the exchanged routing header, and the payload of the fourth data packet is transmitted in step 11916.

Meanwhile, after step 118, a sixth data packet including an IP header and a payload having the third data is received in step 11921. The IP header includes a source address field having an IP address based on the prefix that is recorded in the prefix field of the router advertisement message transmitted in step 118 and a destination address field having the IP address of the external node. Next, the sixth data packet is transmitted in step 11922.

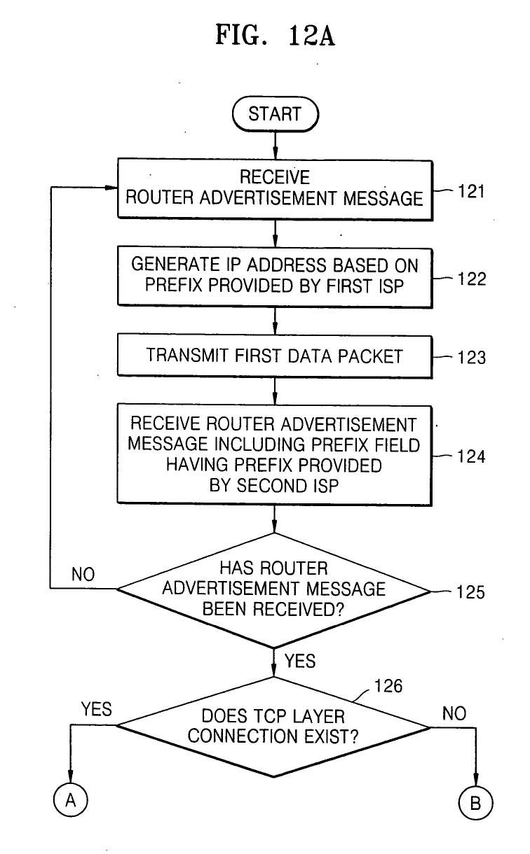

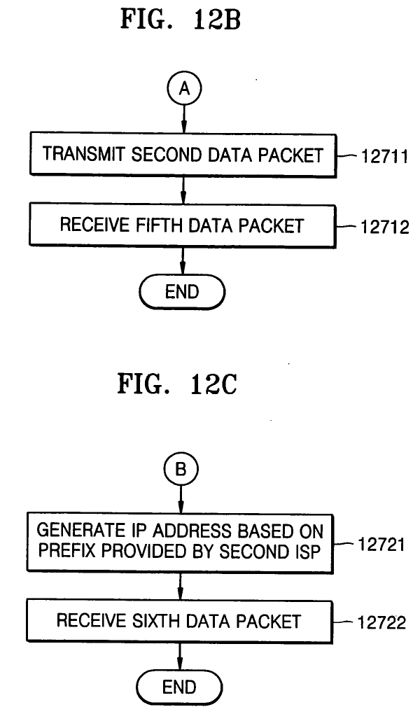

FIGS. 12A through 12C are flowcharts of a method of performing transmission and reception using multiple ISPs according to the embodiment of the present invention.

Referring to FIGS. 12A through 12C, a router advertisement message is received in step 121. The router advertisement message includes a source address field having an IP address provided by a first ISP, a destination address field having an IP address indicating all nodes on a first subnet, and a prefix field having a prefix provided by the first ISP. Next, an IP address is generated based on the prefix that is provided by the first ISP and is recorded in the prefix field included in the received router advertisement message in step 122. A first data packet including an IP header and a payload having first data is transmitted in step 123. The IP header includes a source address field having the generated IP address and a destination address field having an IP address of an external node.

Next, a router advertisement message is received in step 124. The router advertisement message includes a source address field having an IP address provided by a second ISP, a destination address field having the IP address indicating all of the nodes on the first subnet, and a prefix field having a prefix provided by the second ISP.

If it is determined that the router advertisement message including the prefix field having the prefix provided by the second ISP has been received in step 125, and if it is determined that TCP layer connection exists between a source node and a destination node for second data in step 126, a second data packet including an IP header, a routing header, and a payload having the second data is transmitted in step 12711. The IP header includes a source address field having the IP address generated based on the prefix provided by the first ISP that has stopped an Internet access service and a destination address field having the IP address provided by the second ISP that provides the Internet access service. The routing header includes an address field having the IP address of the external node that can be reached via Internet. Next, a fifth data packet including an IP header, a routing header, and a payload having third data is received in step 12712. The IP header includes a source address field having the IP address of the external node that has received the second data packet and a destination address field having the IP address based on the prefix provided by the first ISP. The routing field includes an address field having the IP address provided by the second ISP.

If it is determined that the router advertisement message including the prefix field having the prefix provided by the second ISP has been received in step 125, and if it is determined that TCP layer connection does not exist between a source node and a destination node for the third data in step 126, an IP address is generated based on the prefix that is provided by the second ISP and is recorded in the prefix field included in the received router advertisement message in step 12721. Next, a sixth data packet including an IP header and a payload having the third data is transmitted in step 12722. The IP header includes a source address field having the generated IP address and a destination address field having the IP address of the external node.

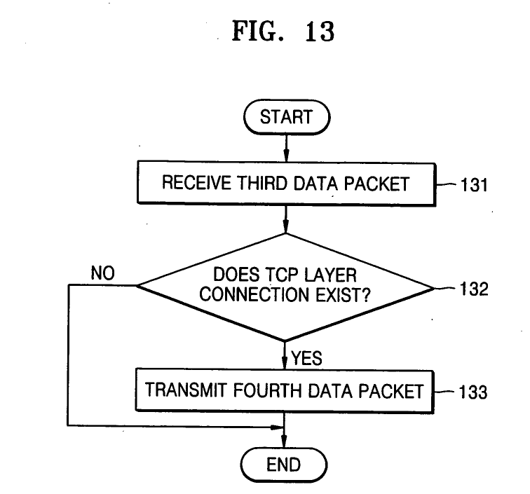

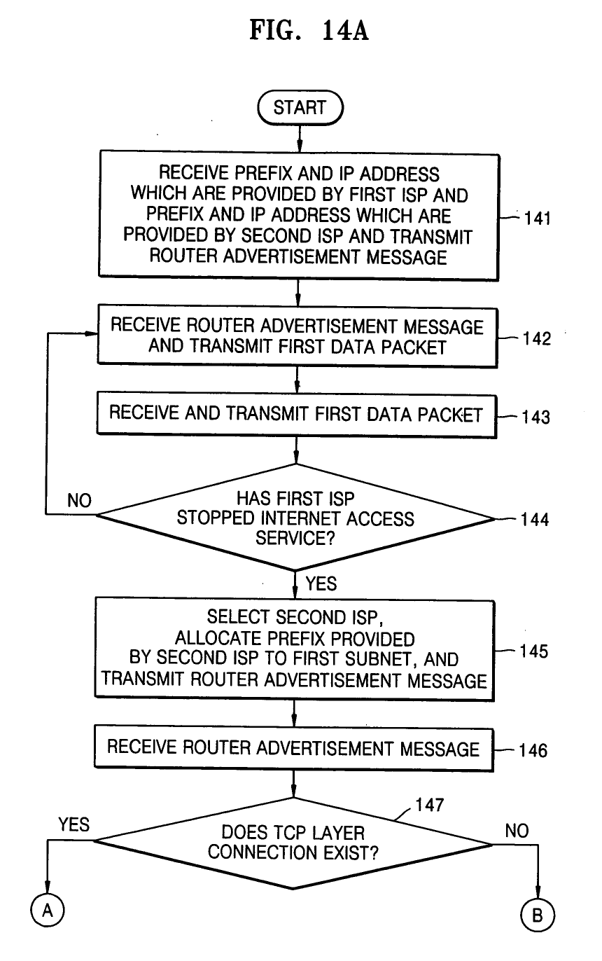

FIG. 13 is a flowchart of another method of performing transmission and reception using multiple ISPs according to the embodiment of the present invention.

Referring to FIG. 13, a third data packet including an IP header, a routing header, and a payload having second data is received in step 131. The IP header includes a source address field having an IP address based on a prefix provided by a first ISP that has stopped an Internet access service and a destination address field having an IP address of an external node that can be reached via Internet. The routing header includes an address field having an IP address provided by a second ISP providing the Internet access service. Next, if it is determined that TCP layer connection exists between a source node and a destination node for third data in step 132, a fourth data packet including an IP header, a routing header, and a payload having the third data is transmitted in step 133. The IP header includes a source address field having the IP address of the external node and a destination address field having the IP address provided by the second ISP. The routing header includes an address field having the IP address based on the prefix provided by the first ISP.

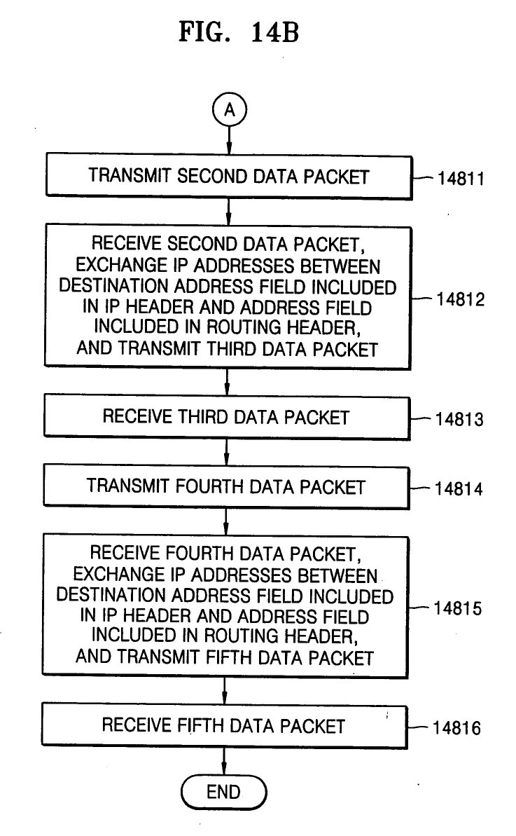

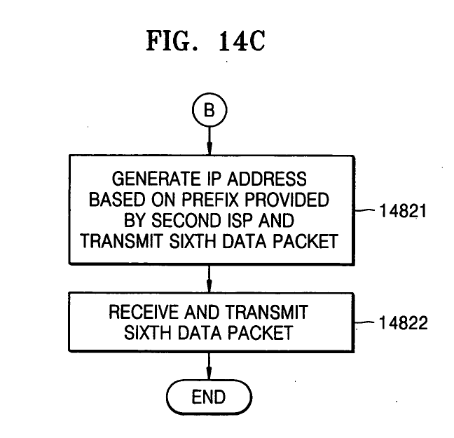

FIGS. 14A through 14C are flowcharts of a method of selecting one among multiple ISPs and using the selected ISP according to the embodiment of the present invention.

Referring to FIGS. 14A through 14C, a prefix and an IP address, which are provided by a first ISP, and a prefix and an IP address, which are provided by a second ISP, are received in step 141. In addition, a router advertisement message is transmitted in step 141. The router advertisement message includes a source address field having the IP address provided by the first ISP, a destination address field having an IP address indicating all nodes on a first subnet, and a prefix field having the prefix provided by the first ISP. Next, the router advertisement message is received, and a first data packet including an IP header and a payload having first data is transmitted in step 142. Here, the IP header includes a source address field having an IP address, which is generated based on the prefix provided by the first ISP and is recorded in the prefix field included in the received router advertisement message, and a destination address field having an IP address of an external node. Next, the first data packet is received and then transmitted in step 143.

If it is determined that the first ISP has stopped an Internet access service in step 144, the second ISP providing the Internet access service is selected in step 145. In addition, the prefix provided by the selected second ISP is allocated to the first subnet that has been allocated the prefix provided by the first ISP, and a router advertisement message is transmitted in step 145. The router advertisement message includes a source address field having the IP address provided by the second ISP, a destination address field having the IP address indicating all of the nodes on the first subnet, and a prefix field having the prefix provided by the second ISP.

Next, the router advertisement message transmitted in step 145 is received in step 146. If it is determined that TCP layer connection exists between a source node and a destination node for second data in step 147, a second data packet including an IP header, a routing header, and a payload having the second data is transmitted in step 14811. The IP header includes a source address field having the IP address, which is generated based on the prefix provided by the first ISP and is recorded in the prefix field included in the router advertisement message received in step 146, and a destination address field having the IP address provided by the second ISP. The routing header includes an address field having the IP address of the external node that can be reached via Internet. Next, in step 14812, the second data packet is received, and the IP addresses are exchanged between the destination address field included in the IP header of the second data packet and the address field included in the routing header of the second data packet. In addition, a third data packet including the exchanged IP header, the exchanged routing header, and the payload of the second data packet is transmitted in step 14812. Next, the third data packet is received in step 14813.

If TCP layer connection exists between a source node and a destination node for third data when the third data packet is received, a fourth data packet including an IP header, a routing header, and a payload having the third data is transmitted in step 14814. Here, the IP header includes a source address field having the IP address of the external node and a destination address field having the IP address provided by the second ISP. The routing header includes an address field having the IP address based on the prefix provided by the first ISP. Next, in step 14815, the fourth data packet is received, and the IP addresses are exchanged between the destination address field included in the IP header of the fourth data packet and the address field included in the routing header of the fourth data packet. In addition, a fifth data packet including the exchanged IP header, the exchanged routing header, and the payload of the fourth data packet is transmitted in step 14815. Next, the fourth data packet is received in step 14816.

After the router advertisement message transmitted in step 145 is received in step 146, if it is determined that TCP layer connection does not exist between the source node and the destination node for the second data in step 147, an IP address is generated based on the prefix that is provided by the second ISP and recorded in the prefix field included in the received router advertisement message, and a sixth data packet including an IP header and a payload having the second data is transmitted in step 14821. Here, the IP header includes a source address field having the generated IP address and a destination address field having the IP address of the external node. Next, the sixth data packet is received and then transmitted in step 14822.

The above-described embodiments of the present invention can be realized as programs, which can be executed in a universal digital computer through a computer readable recording medium. Data structure used in the embodiments of the present invention can be recorded in a computer readable recording medium using various means. The computer readable recording medium may be a storage media, such as a magnetic storage medium (for example, a ROM, a floppy disc, or a hard disc), an optical readable medium (for example, a CD-ROM or DVD), or carrier waves (for example, transmitted through Internet).

According to the present invention, multiple public lines requiring low communication costs are used instead of a private line in an IPv6 environment, thereby securing reliability and decreasing communication costs. In addition, since the multiple public lines are selectively used, even when a certain public line has a problem and cannot provide Internet access, the Internet can be accessed using another public line. The present invention also allows an existing IP address to be continuously used when the Internet is accessed using another public line because a public line that has been used has a problem, thereby maintaining TCP layer connection. As a result, a disadvantage of retransmission or reload of a message or a file is overcome. Moreover, the present invention eliminates the necessity of table mapping of port numbers in a TCP layer in a conventional multi-pass, thereby solving problems of decreasing a throughput and causing a load.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of selecting one among multiple Internet Service Providers (ISPs) and routing using the selected ISP, the method comprising:
(a) exchanging an address of a second ISP replacing a first ISP that has stopped an Internet access service and an address of an external node that has been connected to the first ISP; and
(b) transmitting a data packet having the address of the external node as a next destination address.

2. The method of claim 1, wherein step (a) comprises exchanging the second ISP's address, which is recorded in a destination address field included in an Internet Protocol (IP) header of a data packet transmitted from a node that has set the address of the external node as a final destination address, and the external node's address, which is recorded in an address field included in a routing header of the data packet transmitted from the node.

3. The method of claim 2, wherein step (b) comprises transmitting the data packet comprising an IP header and a routing header that are obtained as results of the exchanging performed in step (a).

4. The method of claim 1, further comprising:
(c) receiving a data packet having the address of the external node as a final destination address and the address of the second ISP as a next destination address,
wherein step (a) comprises exchanging the address of the second ISP included in the data packet received in step (c) and the address of the external node included in the data packet received in step (c).

5. The method of claim 1, further comprising:
(d) receiving a data packet having the address of the external node, which receives the data packet that has been transmitted in step (b), as a source address, an address of a node, which has set the address of the external node as a final destination address, as a final destination address, and the address of the first ISP as a next destination address.

6. The method of claim 5, further comprising:
(e) exchanging the first ISP's address included in the data packet received in step (d) and the node's address included in the data packet received in step (d); and
(f) transmitting a data packet having the node's address as a next destination address.

7. A multiple Internet Service Provider (ISP) selection/routing apparatus comprising:
an Internet Protocol (IP) address exchanger which exchanges an address of a second ISP replacing a first ISP that has stopped an Internet access service and an address of an external node that has been connected to the first ISP; and
a data packet transmitter which transmits a data packet having the address of the external node as a next destination address.

8. The multiple ISP selection/routing apparatus of claim 7, wherein the IP address exchanger exchanges the address of the second ISP, which is recorded in a destination address field included in an Internet Protocol (IP) header of a data packet transmitted from a node that has set the address of the external node as a final destination address, and the address of the external node, which is recorded in an address field included in a routing header of the data packet transmitted from the node.

9. The multiple ISP selection/routing apparatus of claim 8, wherein the data packet transmitter transmits the data packet comprising an IP header and a routing header that are obtained as results of the exchanging performed by the IP address exchanger.

10. The multiple ISP selection/routing apparatus of claim 7, further comprising:
a data packet receiver which receives a data packet having the address of the external node as a final destination address and the address of the second ISP as a next destination address,
wherein the IP address exchanger exchanges the address of the second ISP included in the data packet received by the data packet receiver and the address of the external node included in the data packet received by the data packet receiver.

11. The multiple ISP selection/routing apparatus of claim 7, further comprising a data packet receiver which receives a data packet having the address of the external node, which receives the data packet that has been transmitted from the data packet transmitter, as a source address, an address of a node, which has set the address of the external node as a final destination address, as a final destination address, and the address of the first ISP as a next destination address.

12. The multiple ISP selection/routing apparatus of claim 11, wherein the IP address exchanger exchanges the address of the first ISP included in the data packet received by the data packet receiver and the address of the node included in the data packet received by the data packet receiver, and the data packet transmitter transmits a data packet having the address of the node as a next destination address.

13. A method of performing transmission and reception using multiple Internet Service Providers (ISPs), the method comprising:
(a) receiving a router advertisement message comprising an address of a second ISP replacing a first ISP that has stopped an Internet access service; and
(b) transmitting a data packet having an address of the external node, which has been connected to the first ISP, as a final destination address, and the address of the second ISP comprised in the router advertisement message as a next destination address.

14. The method of claim 13, further comprising:
transmitting a data packet comprising an Internet Protocol (IP) header including a destination address field, in which the address of the second ISP is recorded, and a routing header including an address field, in which the address of the external node is recorded.

15. The method of claim 13, further comprising:
receiving a data packet having the address of the external node, which has received the data packet transmitted in step (b), as a source address and an address of a node, which has set the address of the external node as a final destination address, as a final destination address.

16. The method of claim 13, wherein when Transmission Control Protocol (TCP) layer connection exists, step (b) comprises transmitting a data packet comprising an Internet Protocol (IP) header having a source address field in which an address based on a prefix provided by the first ISP is recorded.

17. The method of claim 13, further comprising:
when Transmission Control Protocol (TCP) layer connection does not exist, transmitting a data packet comprising an Internet Protocol (IP) header having a source address field in which an address based on a prefix provided by the second ISP is recorded.

18. A computer readable recording medium for storing a program for executing in a computer a method of selecting one among multiple Internet Service Providers (ISPs) and routing using the selected ISP, the method comprising:
exchanging an address of a second ISP replacing a first ISP that has stopped an Internet access service and an address of an external node that has been connected to the first ISP; and
transmitting a data packet having the address of the external node as a next destination address.

19. A computer readable recording medium for storing a program for executing in a computer a method of performing transmission and reception using multiple Internet Service Providers (ISPs), the method comprising:
receiving a router advertisement message comprising an address of a second ISP replacing a first ISP that has stopped an Internet access service; and
transmitting a data packet having an address of the external node, which has been connected to the first ISP, as a final destination address, and the address of the second ISP comprised in the router advertisement message as a next destination address.
